(19) United States
(12) Patent Application Publication
(10) Pub. No.: US 2026/0045004 A1
(43) Pub. Date: Feb. 12, 2026

(54) Systems and methods for generating object outlines

(71) Applicant: Canva Pty Ltd, Surry Hills (AU)

(72) Inventors: René Unrau, Vienna (AT); Christopher James Cook, Ryde (AU)

(73) Assignee: Canva Pty Ltd, Surry Hills (AU)

(21) Appl. No.: 19/249,698

(22) Filed: Jun. 25, 2025

(30) Foreign Application Priority Data
Aug. 8, 2024 (AU) 2024205619

(51) Int. Cl. G06T 11/20; G06T 3/40; G06T 11/00; G06T 11/60

(52) U.S. Cl. CPC G06T 11/203; G06T 3/40; G06T 11/001; G06T 11/60; G06T 2200/24

(57) ABSTRACT

Described herein is a computer implemented method including displaying an image at a first zoom level on a display and then generating first display adjusted distance field data based on distance field data associated with the image and one or more context inputs, wherein the one or more context inputs includes the first zoom level. The method further includes generating, based on the first display adjusted distance field data, a first dynamic segment outline corresponding to a first segment of the image, wherein the first dynamic segment outline has a first outline thickness that substantially equals a display thickness, the display thickness being substantially the same for any zoom level.

### CROSS-REFERENCE TO RELATED APPLICATION

This application is a U.S. Non-Provisional Application that claims priority to Australian Patent Application No. 2024205619, filed Aug. 8, 2024, which is hereby incorporated by reference in its entirety.

### TECHNICAL FIELD

Aspects of the present disclosure are directed to systems and methods for generating object outlines.

### BACKGROUND

Various computer applications for editing digital images exist. Generally speaking, such applications allow users to change an image by adding elements (such as lines, shapes and/or text) and/or adding visual effects to an image (such as applying colour schemes, thematic effects, etc.)

Users may also wish to edit a specific object within an image. Such objects may be identifiable by the use of certain graphical effects that detect and highlight or otherwise emphasise objects. Where there are a number of different objects in an image that are identified, these objects may also somehow be differentiated from each other. This may be done through various graphical effects and/or by labelling each different object.

Background information described in this specification is background information known to the inventors. Reference to this information as background information is not an acknowledgment or suggestion that this background information is prior art or is common general knowledge to a person of ordinary skill in the art.

### SUMMARY

Described herein is a computer implemented method including: displaying an image at a first zoom level on a display; generating first display adjusted distance field data based on distance field data associated with the image and one or more context inputs, wherein the one or more context inputs includes the first zoom level; and generating, based on the first display adjusted distance field data, a first dynamic segment outline corresponding to a first segment of the image, wherein the first dynamic segment outline has a first outline thickness that substantially equals a display thickness, the display thickness being substantially the same for any zoom level.

Also described herein is a computer implemented method for generating distance field data including: accessing image data in respect of an image; receiving segmentation data associated with the image, wherein the segmentation data defines one or more segments in the image; processing the segmentation data to generate edge segmentation data, wherein for each segment the edge segmentation data defines a corresponding segment edge; and processing the segmentation data and the edge segmentation data to generate the distance field data, wherein the distance field data includes for each pixel of the image a pixel distance value, and wherein each pixel distance value indicates a distance between each pixel and its nearest segment edge.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings:

FIG. 1 is a diagram depicting a system in which various features of the present disclosure may be implemented.

FIG. 2 is a block diagram of a computer processing system configurable to perform various features of the present disclosure.

FIG. 3 depicts an example representation of a graphical user interface.

FIG. 4 depicts operations performed in a method for generating and displaying object outlines in respect of a digital image.

FIG. 5 depicts operations performed in a method for generating a customised distance field.

FIG. 6 depicts operations performed in a method for determining an outline area component of a dynamic segment outline.

FIG. 7A depicts an example image.

FIG. 7B depicts an example segmentation mask corresponding to the image of FIG. 7A.

FIG. 8 depicts an example edge segmentation mask corresponding to the segmentation mask of FIG. 7B.

FIG. 9A depicts an example overlay with dynamic segments outlines corresponding to the segmentation mask of FIG. 7B.

FIG. 9B depicts another example overlay with selected dynamic segments outlines corresponding to the segmentation mask of FIG. 7B.

FIG. 10 depicts a series of example representations demonstrating a process of generating a display adjusted from a customised distance field.

FIG. 11 depicts a series of user interface examples.

FIG. 12 depicts a series of tables including example pixel distance values.

FIG. 13 depicts a series of tables including example outline values in respect of various example zoom levels based on the example pixel distance values of FIG. 12.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

The present disclosure is directed to systems and methods for generating and displaying object outlines in respect of a digital image. In the context of the present specification, reference to an image is reference to a raster image.

As discussed above, computer applications for use in editing digital images are known. Such applications will typically provide mechanisms for a user to edit or modify digital images. This may include selecting and editing specific objects in an image. Selecting an object may be facilitated by applying a visual effect to that object, or to an area of the image upon which that object resides.

Once such way a visual effect may be applied to an object is by the use of a segmentation mask that overlies the digital image, i.e. an original image. In examples herein, a segmentation mask (e.g. a binary segmentation mask) may be defined by segmentation data that includes a pixel (e.g. a segmentation pixel) corresponding to each original image pixel. Each segmentation pixel takes a value (e.g. a RGB value) that indicates whether or not the corresponding original image pixel is part of an identified segment (and, potentially, which specific segment) or not. For example, all segmentation pixels that correspond to a first object that has been identified in the original image may take a first RGB value (e.g. a particular shade of purple) identifying a first segment, all segmentation data pixels that correspond to a second object that has been identified in the original image may take a second RGB value (e.g. a particular shade of green) identifying a second segment, and all segmentation data pixels that do not correspond to any identified object may take a further (different) RGB value (e.g. black) identifying a non-segment area.

The techniques disclosed herein are described in the context of a design platform that is configured to facilitate various operations concerned with digital designs. In the context of the present disclosure, these operations relevantly include displaying and editing digital images.

A design platform may take various forms. In the embodiments described herein, the design platform is described as a stand-alone platform (e.g. a single application or set of applications that run on a user's computer processing system and perform the techniques described herein without requiring server-side operations). The techniques described herein can, however, be performed (or be adapted to be performed) by a client-server type design platform (e.g. one or more client applications and one or more server applications that interoperate to perform the described techniques).

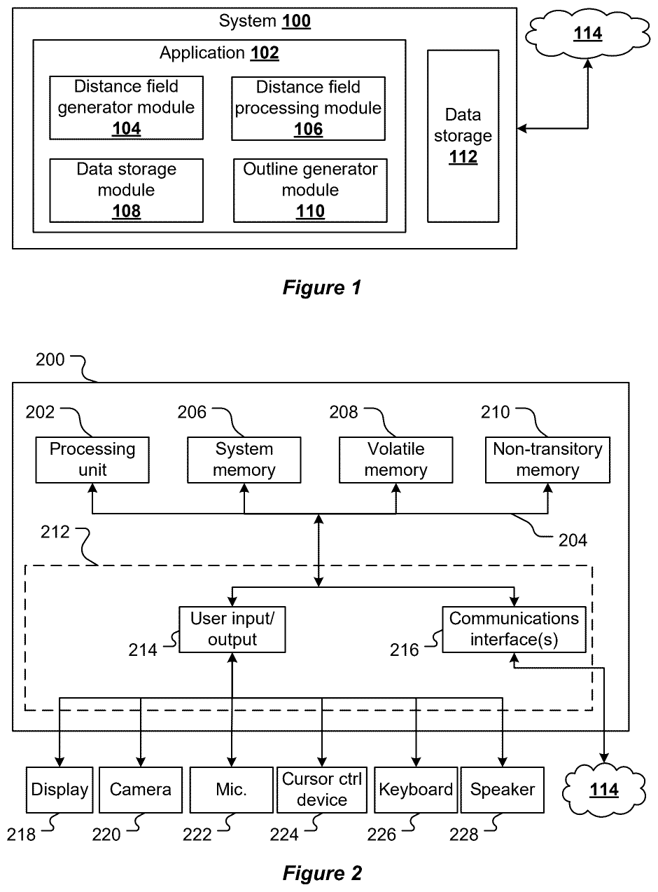

FIG. 1 depicts a computer processing system 100 that is configured to perform the various functions described herein. System 100 may be any suitable type of computer processing system, for example a desktop computer, a laptop computer, a tablet device, a smart phone device, or an alternative computer processing system.

In this example, computer system 100 is configured to perform the functions described herein by execution of an image editing software application 102—that is, computer readable instructions that are stored in a storage device (such as non-transitory memory 210 described below) and executed by a processing unit of the system 100 (such as processing unit 202 described below).

In the present example, application 102 (and/or other applications of system 100) facilitates various functions related to editing digital images. These functions may be facilitated by application 102 generating a user interface and co-ordinating processing of inputs from a user via that user interface. In the present example, application 102 includes modules that handle specific processing steps, in particular a distance field generator module 104, a distance field processing module 106, a data storage module 108, and an outline generator module 110. These modules and their specific functionality will be described in detail further below.

In embodiments where a client-server architecture is utilised, one or more of the modules may be provided as (or part of) a remote application (e.g. a service provided by a server that the application interacts with by way of network 114).

Along with image editing, the various functions facilitated by application 102 may include, for example, image (and design) storage, organisation, searching, retrieval, viewing, sharing, publishing, and/or other functions related to digital designs and digital images. Such functions may be provided by application 102 and/or by other modules running on system 100 or an alternative system.

In the example of FIG. 1, system 100 is connected to a communications network 114. Via network 114, system 100 can communicate with (e.g. send data to and receive data from) other computer processing systems (not shown). The techniques described herein can, however, be implemented on a stand-alone computer system that does not require network connectivity or communication with other systems.

Data storage module 108 may, for example, provide relational database management functionality (or an alternative functionality) for storing and retrieving data from data storage 112. Data storage 112 may be any appropriate data storage device (or set of devices), for example one or more non transitory computer readable storage devices such as hard disks, solid state drives, tape drives, or alternative computer readable storage devices.

Application 102, by way of data storage module 108, persistently stores data to data storage 112. In alternative implementations, however, application 102 may be configured to interact with data storage devices such as 112 via one or more separate data storage application to store and retrieve data. In examples where multiple separate data storage applications are used, one data storage application may be used for one type of data (e.g. user account data), another for another type of data (e.g. image data), another for yet another type of data (e.g. distance field data), and so forth. In this case, each data storage application may interface with one or more shared data storage devices and/or one or more dedicated data storage devices, and each data storage application may receive/respond to requests from various applications (including, for example application 102).

In FIG. 1, system 100 is depicted as having/executing a single application 102. However, system 100 may (and typically will) include additional applications (not shown). For example, and assuming application 102 is not part of an operating system application, system 100 will include separate operating system application (or group of applications).

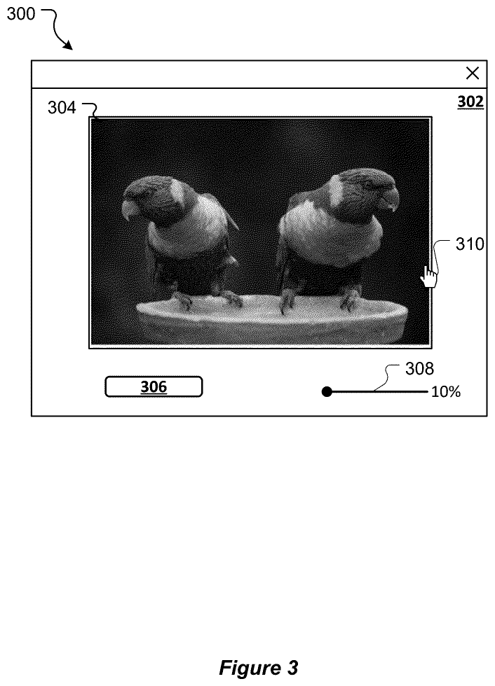

Turning to FIG. 2, a block diagram depicting hardware component of a computer processing system 200 is provided. The computer processing system 100 of FIG. 1 may be a computer processing system such as 200 (though alternative hardware architectures are possible).

Computer processing system 200 includes at least one processing unit 202. Processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable by (either in a shared or dedicated manner) system 200.

Through a communications bus 204 the processing unit 202 is in data communication with a one or more machine readable storage devices (also referred to as memory devices). Computer readable instructions and/or data which are executed by the processing unit 202 to control operation of the processing system 200 are stored on one more such storage devices. In this example system 200 includes a system memory 206 (e.g. a BIOS), volatile memory 208 (e.g. random access memory such as one or more DRAM modules), and non-transitory memory 210 (e.g. one or more hard disk or solid state drives). In the present examples, data storage 112 may include each of system memory 206, volatile memory 208, and non-transitory memory 210.

System 200 also includes one or more interfaces, indicated generally by 212, via which system 200 interfaces with various devices and/or networks. Other devices may be integral with system 200, or may be separate. Where a device is separate from system 200, connection between the device and system 200 may be via wired or wireless hardware and communication protocols, and may be a direct or an indirect (e.g. networked) connection.

Depending on the particular system in question, devices to which system 200 connects—whether by wired or wireless means—include one or more input devices to allow data to be input into/received by system 200 and one or more output device to allow data to be output by system 200.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228.

As another example, where system 200 is a portable personal computing device such as a smart phone or tablet it may include a touchscreen display 218, a camera device 220, a microphone device 222, and a speaker device 228.

Alternative types of computer processing systems, with additional/alternative input and output devices, are possible.

System 200 also includes one or more communications interfaces 216 for communication with a network, such as network 114 of FIG. 1. Via the communications interface(s) 216, system 200 can communicate data to and receive data from networked systems and/or devices.

System 200 stores or has access to computer applications (also referred to as software or programs)—i.e. computer readable instructions and data which, when executed by the processing unit 202, configure system 200 to receive, process, and output data. Instructions and data can be stored on non-transitory machine-readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, in FIG. 1 computer processing system 100 (which may be or include the hardware components of computer processing system 200) includes and executes application 102.

In some cases, part or all of a given computer-implemented method will be performed by system 200 itself, while in other cases processing may be performed by other devices in data communication with system 200.

It will be appreciated that FIG. 2 does not illustrate all functional or physical components of a computer processing system. For example, no power supply or power supply interface has been depicted. However, system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

The present disclosure describes methods and processing as being performed by application 102 coordinating operation of distance field generator module 104, distance field processing module 106, data storage module 108, and outline generator module 110. Each of modules 104, 106, 108 and 110 may be software modules such as an add-on or plug-in that operates in conjunction with application 102 to expand the functionality thereof.

In certain embodiments, distance field generator module 104 (coordinated by application 102) operates to process source segmentation data (e.g. a source segmentation mask) associated with a digital image thereby to generate distance field data (e.g. a customised distance field). In certain embodiments, distance field processing module 106 (coordinated by application 102) operates to process distance field data (e.g. a customised distance field generated by distance field generator module 104) thereby to generate display adjusted distance field data (e.g. a display adjusted distance field portion). In certain embodiments, outline generator module 110 (coordinated by application 102) operates to process display adjusted distance field data (e.g. a display adjusted distance field generated by distance field processing module 106) and image data associated with the image thereby to generate output segment data (e.g. a dynamic segment outline corresponding to each object on the image that is chosen for display).

Specific operations performed by each of distance field generator module 104, distance field processing module 106, data storage module 108, and outline generator module 110 are described in detail further below.

In the illustrated embodiment, modules 104, 106, 108 and 110 are described as being part of (i.e. coordinated by) application 102. In alternative embodiments, the functionality provided by one or more of modules 104, 106, 108 and 110 may be natively provided by application 102 (i.e. application 102 itself has instructions and data which, when executed, cause application 102 to perform part or all of the functionality described herein). In still further alternative embodiments, one or more of modules 104, 106, 108 and 110 may be a stand-alone application that runs on which communicates with application 102. Further, those one or more stand-alone applications may run on system 100 or run on one or more other systems that communicate with system 100 via network 114.

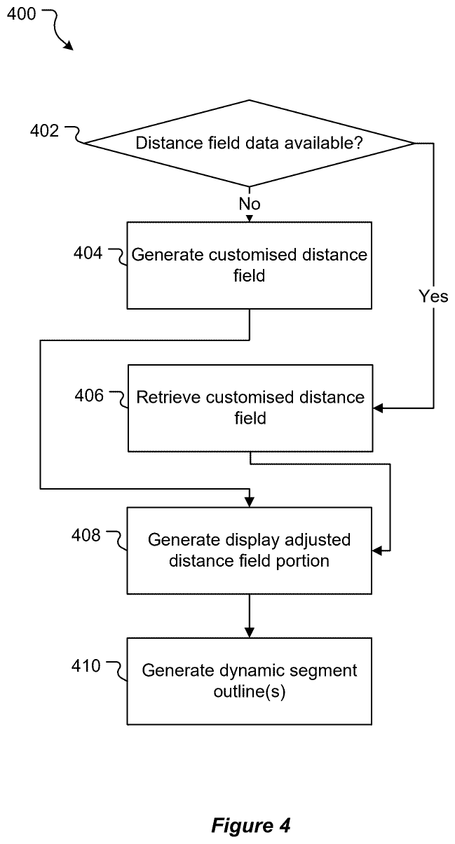

Referring to FIG. 3, in the present disclosure, application 102 configures system 100 to generate and display (e.g. on a touch screen or other display such as 218) an image editor user interface (UI) 300. Generally speaking, UI 300 will allow a user to (inter alia) select, display, edit, and save a digital image. FIG. 3 provides a simplified and partial example of a user interface. In this example UI 300 is a graphical user interface (GUI).

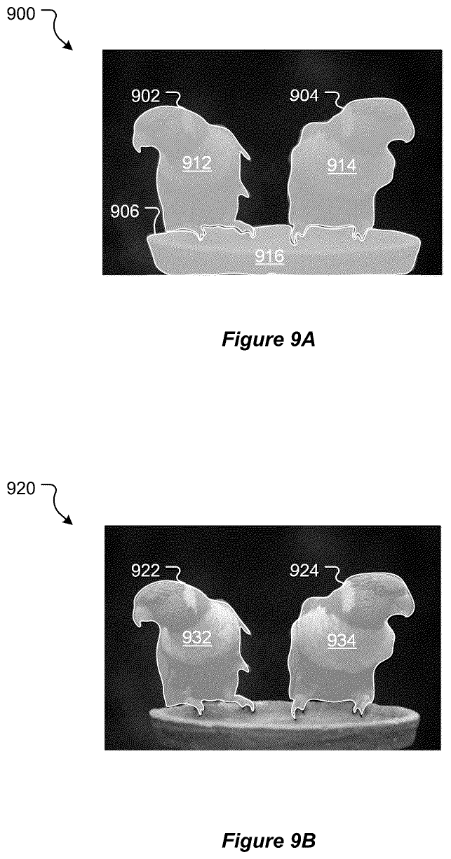

UI 300 includes an image preview area 302. Image preview area 302 may, for example, be used to display an image 304 (or, in some cases multiple images) that is being or to be edited. In this example, preview area 302 is being used to display a preview of image 700 of FIG. 7A. Preview area 302 may be manually re-sizable by a user to be smaller (to a minimum size limit) or bigger (to a maximum size limit that is limited to a size the display, e.g. display 218). The size of preview area 302 may therefore contribute to what portion of image 304 is visible to the user.

In this example, UI 300 also includes an identify objects control 306 which, if activated by a user, causes application 102 to process an image (e.g. the displayed image) to identify and display objects within that image by way of generating and displaying object outlines in respect of the objects. This processing is described further below.

UI 300 also includes a zoom control 308 which a user can interact with to zoom into/out of the image currently displayed. The zoom level, along with defining the magnification of image 394, may also contribute to what portion of image 304 is visible to the user.

A user can interact with UI 300 in various ways depending on the hardware available. For example, a user may control a cursor 310 via cursor control device 224. Alternatively, if the display is a touch screen display a user may interact with UI 300 by contacts and/or gestures with the display.

Whilst not illustrated in FIG. 3, UI 300 may also facilitate other functionality. For example, UI 300 may include one or more controls to search for existing images and/or other assets that application 102 makes available to a user to assist in editing images. Different types of assets may be made available, for example visual design elements of various types (e.g. text elements, geometric shapes, charts, tables, and/or other types of design elements), media of various types (e.g. photos, vector graphics, shapes, videos, audio clips, and/or other media), design templates, design styles (e.g. defined sets of colours, font types, and/or other assets/asset parameters), and/or other assets that a user may use when editing an image.

Depending on implementation, the existing images and/or other assets may be accessed from various locations. For example, search functionality invoked by one or more search controls may cause application 102 to search for existing images and/or assets that are stored in locally accessible memory of system 100 on which application 102 executes (e.g. non-transitory memory such as 210 or other locally accessible memory), assets that are stored at a remote server (and accessed via network 114), and/or assets stored on other locally or remotely accessible devices.

As a further example, UI 300 may also include one or more image editing controls, for example controls that allow a user to perform pixel-level operations on the image or on a selected object (or set of objects) in the image. These may include, for example, controls such as cut, copy, paste, brightness adjustment, contrast adjustment, saturation adjustment, black point adjustment, highlights adjustment, shadows adjustment, and/or other image editing controls.

Once an image has been edited, application 102 may provide various options for outputting that image. For example, application 102 may provide a user with options to output an image by one or more of: saving the image to local memory of system 100 (e.g. data storage 112 such as non-transitory memory 210) which may use a save control (where this option may be presented to the user following interaction with the save control); saving the image to remotely accessible memory device which may also use the same or an alternative save control (again where this option may be presented to the user following interaction with the same or alternative save control); uploading the image to a server system; printing the image to a printer (local or networked); communicating the image to another user (e.g. by email, instant message, or other electronic communication channel); publishing the image to a social media platform or other service (e.g. by sending the image to a third party server system with appropriate API commands to publish the image); and/or by other output means.

Where application 102 operates to display controls, interfaces, or other objects, application 102 does so via one or more displays that are connected to (or integral with) system 100—e.g. display 218. Where application 102 operates to receive or detect user input, such input is provided via one or more input devices that are connected to (or integral with) system 100—e.g. a touch screen, a touch screen display 218, a cursor control device 224, a keyboard 226, a microphone device 222, and/or an alternative input device.

In the present context, image data in respect of a particular image may be stored in an image record. Generally speaking, an image record defines certain image data attributes. By way of example, an image record may include attributes such as: image identifier (data identifying the image: e.g. a filename or another unique image identifier); location (data defining the storage location of the image: e.g. a hyperlink or a folder path); resolution (data defining the pixel resolution of the image: e.g. a (pixel width, pixel height) pair); creation time (data defining the time and date the image was created: e.g. a time stamp) and edit time (data defining the time and date the image was last edited: e.g. a time stamp).

In the present context, source segmentation data is the segmentation data defining a source segmentation mask corresponding to a digital image. Source segmentation data in respect of a particular image may be stored in a segmentation record. Generally speaking, a segmentation record defines certain segmentation data attributes. By way of example, a segmentation record may include attributes such as: segmentation mask identifier (data identifying the segmentation mask: e.g. a filename or another unique segmentation identifier); location (data defining the storage location of the segmentation mask: e.g. a hyperlink or a folder path); resolution (data defining the pixel resolution of the segmentation mask: e.g. a (pixel width, pixel height) pair); segment pixel values (e.g. an array or other dataset); creation time (data defining the time and date the segmentation mask was created: e.g. a time stamp) and edit time (data defining the time and date the segmentation mask was last edited: e.g. a time stamp). In other embodiments, a segmentation record may further include an associated image attribute. This attribute includes data identifying the image of which the segmentation data is associated. This may, for example, be one or more of the image identifier attribute of the associated image, the location attribute of the associated image, or other data that may be used to identify the associated image.

For example, referring to FIGS. 7A and 7B, segmentation mask 710 is the source segmentation mask corresponding to image 700. Image 700 includes three identified objects: a first lorikeet 702; a second lorikeet 704; and a birdbath 706. Segmentation mask 710 include three segments that correspond to the three objects of image 700: a first segment 712 (corresponding to first lorikeet 702); a second segment 714 (corresponding to second lorikeet 704); and a third segment 716 (corresponding to birdbath 706). In this case, segmentation pixels corresponding to the first segment 712 are purple in colour, segmentation pixels corresponding to the second segment 714 are green in colour and segmentation pixels corresponding to the third segment 716 are blue in colour. The area of image 700 not occupied by the three identified objects, for present purposes, does not include any identified objects. Therefore, segmentation mask 710 includes a black area 718 corresponding to the area of image 700 not occupied by the three identified objects.

In the present context, distance field data refers to data in respect of a distance field that may be used to generate a dynamic segment outline in line with the methods described herein. Distance field data in respect of a particular image may be stored in a distance field record, all distance field records forming a set of distance field records. Generally speaking, a distance field record defines certain distance field data attributes. By way of example, a distance field record may include attributes such as: distance field identifier (data identifying the distance field: e.g. a filename or another unique segmentation identifier); maximum distance value (data indicating a maximum distance of a pixel from a segment edge, which will be explained in further detail below); location (data defining the storage location of the distance field: e.g. a hyperlink or a folder path); creation time (data defining the time and date the segmentation mask was created: e.g. a time stamp) and edit time (data defining the time and date the segmentation mask was last edited: e.g. a time stamp).

The distance field data further includes a set of distance field pixel values. Each distance field pixel value corresponds to a pixel of the image with which the distance field is associated, and each distance field pixel value includes (or is associated with) a pixel distance value and a segment identifier. For a given distance field pixel value, the pixel distance value indicates the distance between the corresponding image pixel and a nearest segment edge (and, in the present embodiments, whether the pixel is inside a segment or outside a segment). For a given distance field pixel value, the segment identifier indicates which particular segment the pixel is closest to (or within) (e.g. the segment identifier may be the RGB value of the relevant segment in the segmentation mask).

The set of distance field records may be stored in a lookup table data structure whereby each distance field record is one value of a key value pair, the other key value pair being an identifier of the associated source image (e.g. image mask identifier attribute). In other embodiments, the other key value pair may be an identifier of the associated segmentation mask (e.g. segmentation mask identifier attribute which in turn will be identified as being associated with the source image). In yet other embodiments, each distance field record may be stored separate to the lookup table data structure, and the lookup table key value pairs may be: an identifier of the distance field (e.g. distance field identifier attribute); and an identifier of the associated image.

In alternate embodiments, instead or in addition to the set of distance field records being stored in a lookup table data structure, a distance field record may include an associated image attribute. This attribute includes data identifying the image of which the distance field data is associated. This may, for example, be one or more of the image identifier attribute of the associated image, the storage location of the associated image, or other data that may be used to identify the associated image.

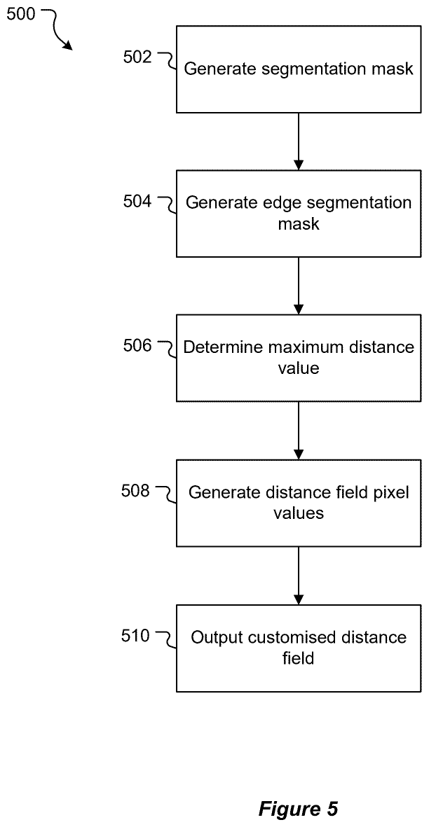

Turning to FIG. 4, a computer implemented method 400 for methods for generating and displaying object outlines in respect of a digital image will be described. The operations of method 400 will be described as being performed by application 102, including co-ordinating processing by modules 104, 106, 108 and 110, running on system 100. In alternative embodiments, however, the processing described may be performed by one or more alternative applications or modules running on system 100 and/or other computer processing systems.

Method 400 is carried out on an image. Thus, a pre-step of method 400 is the selection of an image for processing. This input may be provided, for example, by way of the user selecting an image for processing via a UI 300 (or an alternative UI). In the present embodiments, once a user has selected an image it is displayed in image preview area 302. For instance, the image may be a photograph, e.g. image 800. As mentioned above, the image is a raster image. In certain embodiments, application 102 may allow a user to select a non-raster image to be processed according to method 400 (e.g. a vector graphic). However, in this case application 102 will rasterise the non-raster image before processing it according to method 400. In the present context, the image may be accessed from a data storage (e.g. data storage 112 accessed via data storage module 108). However, in other embodiments, the image may be is accessed from a remote data storage that is in communication with system 100 e.g. by way of network 114. As stated above, the selected image may be associated with a source segmentation mask.

Application 102 may be configured to perform method 400 (or certain operations thereof) at various times. For example, application 102 may be configured to perform method 400 on demand—for example in response to a request to perform method 400. Such a request may, for example, be generated based on a user interacting with UI 300, such as interacting with identify objects control 306, which initiates method 400. In this case method 400 may be performed on an image currently displayed in image preview area 302. Alternatively, if no image is currently displayed, activation of control 306 may cause application 102 to display an image selection user interface via which a user can search or browse for, and select, an image. Application 102 may also, or alternatively, be configured to automatically perform method 400 (or certain operations thereof). As one example, when an image is displayed in image preview area 302 application 102 may automatically perform method 400.

Once the image is selected for processing, at 402, application 102 will determine whether or not the selected image has associated distance field data. In present examples, distance field data may define a prior generated customised distance field in respect of the selected image. Data storage module 108 may access the set of distance field records to determine if a distance field record exists that is associated with the selected image (e.g. utilising the lookup-table data storage structure).

In embodiments where distance field data includes an associated image attribute, data storage module 108 may carry out a search of the associated image attribute of each stored distance field data record (which may, for example, be stored in data storage 112), to determine if there exists distance field data (including a prior generated customised distance field) associated with the selected image. In other embodiments, application 102 will determine whether or not the selected image has associated distance field data using alternate data and/or alternate techniques.

If data storage module 108 determines that a distance field record (including a prior generated customised distance field) does exist for the selected image, data storage module 108 retrieves the associated distance field data including the associated prior generated customised distance field at 406 and feeds it into distance field processing module 106.

If data storage module 108 determines that a distance field record does not exist for the selected image, application 102 initiates a distance field data generation process at 404 to generate a customised distance field for the selected image.

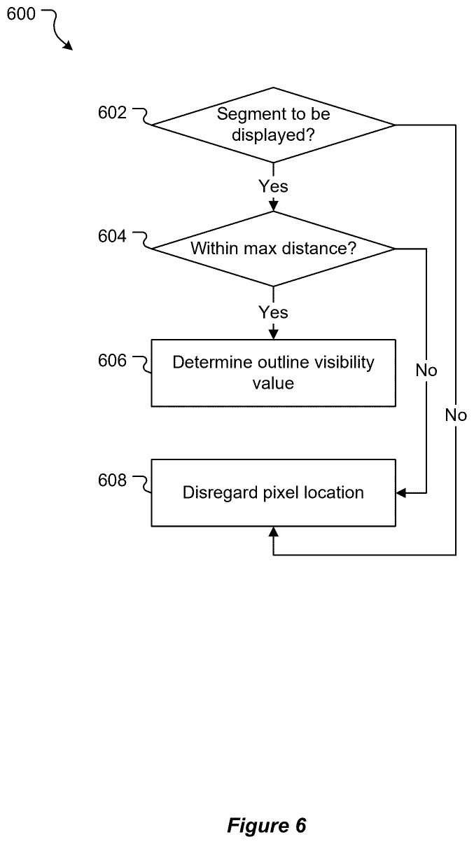

As discussed above, the distance field data that is generated for the selected image includes a distance field pixel corresponding to each selected image pixel, with each distance field pixel including a distance value and a segment identifier. A method 500 for processing an image to generate a customised distance field is described below with reference to FIG. 5.

At 408, distance field processing module 106 receives the customised distance field retrieved by data storage module 108 (at 406) or the customised distance field generated by distance field generator module 104 (at 404) and generates display adjusted distance field data defining a display adjusted distance field portion. The display adjusted distance field portion is a specific portion of the customised distance field having a context-dependent resolution and representing the portion of the image that is visible to the user. Distance field processing module 106 processes the customised distance field and one or more context inputs. In present examples, the one or more context inputs includes: a visible image portion, i.e. the present portion of the image that is presently visibly displayed to the user (e.g. the entirety of the image may be presently displayed or a portion of the image e.g. if a user is zoomed in and/or has reduced the size of a re-sizable viewing area of the image such as preview area 302); a present zoom level of the image as presently displayed to the user; and a display resolution, i.e. the resolution of the user's display (e.g. display 218). Based on the context inputs, distance field processing module 106 calculates a display adjusted resolution (i.e. the context-dependent resolution) for the visible image portion at the present zoom level to be displayed on the user's display.

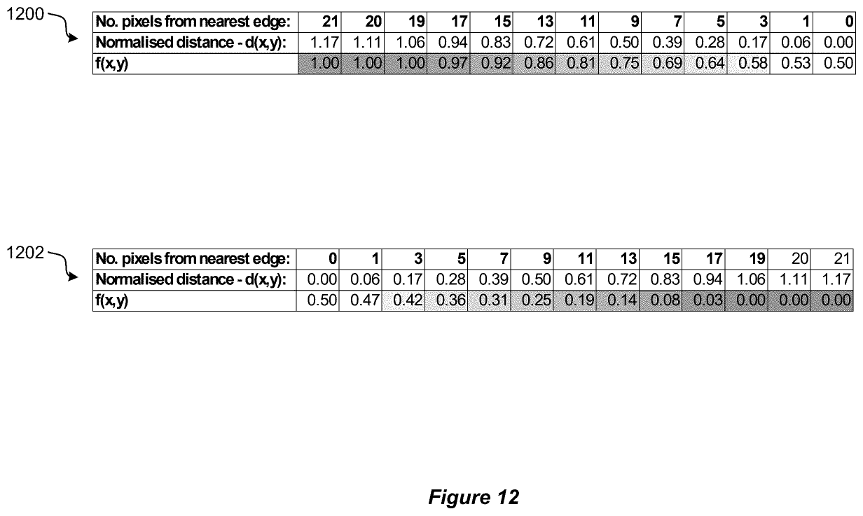

An example demonstrating various process stages of distance field processing module 106 generating a display adjusted distance field based on a customised distance field and context inputs is described with reference to FIG. 10. An example of a customised distance field 1000 is depicted for the entire selected image (e.g. as retrieved by data storage module 108 at 406 or as generated by distance field generator module 104 at 404). In this example, the selected image has an image resolution of 16×10 (width×height) pixels. Thus, customised distance field 1000 is shown with various values (as depicted by the levels of shading of each square pixel) as this 16×10 image resolution. To obtain a first context input, distance field processing module 106 detects a portion of the image that is displayed to the user, visible image portion denoted by reference 1002. Visible portion 1002 is a portion of selected image 1000 that is 4×6 pixels. Distance field processing module 106 isolates this portion as isolated visible portion 1004 (again, being 4×6 pixels in size). To obtain a second context input, distance field processing module 106 detects the present zoom level of isolated visible portion 1004. In this example, distance field processing module 106 detects isolated visible portion 1004 has been zoomed in, with the zoomed-in isolated visible portion denoted as reference 1006. Distance field processing module 106 then generates a raw display adjusted distance field portion 1008 which, as depicted, provides the zoomed-in isolated visible portion 1006 at a resolution based on a third context input, the display resolution, i.e. a display adjusted resolution. In this example, the display resolution (16×24 pixels) is a higher resolution than the resolution of the zoomed-in isolated visible portion 1006 (4×6 pixels). Finally, distance field processing module 106 uses interpolation techniques, e.g. nearest neighbour interpolation, to interpolate the values of visible portion 1002 in view of the display resolution to generate (from the raw display adjusted distance field portion) the display adjusted distance field portion 1010. In other examples, other interpolation techniques may be used.

Where application 102 detects a change in any of the context inputs (e.g. the present zoom level and/or the visible image portion), distance field processing module 106 will repeat 408 with the new context inputs (e.g. new present zoom level and/or new visible image portion). Therefore, distance field processing module 106 generates a display adjusted distance field portion based on the present zoom level and the present portion of the image that is visible to the user. Importantly, the same customised distance field for the selected image is used for that image, without the need for re-generation of the customised distance field for the selected image.

Once the display adjusted distance field portion is generated, distance field processing module 106 will feed the generated display adjusted distance field portion into outline generator module 110.

Outline generator module 110 receives the display adjusted distance field portion generated by distance field processing module 106 (at 408) and, at 410, generates output segment data defining one or more dynamic segment outlines. A dynamic segment outline is the visually displayed outline of the segments that are selected to be visible to user. Each dynamic segment outline may include the following components: an outline area component defining an area of the dynamic segment outline that defines a uniform display thickness of the dynamic segment outline as it is to be displayed to the user; and an outline visual effect component defining the visual effect applied to the dynamic segment outline.

As one example, outline generator module 110 may be configured to determine an outline area component according to method 600 described below. The determined outline area component may be the same for all segments to be displayed and will be based on the maximum distance value of the customised distance field.

Once the outline area component is determined, outline generator module 110 applies a visual effect for the dynamic segment outline as defined by the outline visual effect component. Various visual effects may be applied. For instance, in one embodiment, a “fade-out” effect may be applied using an appropriate technique (e.g. a smoothstep function). In other embodiments, other visual effects such as a hard cut-off effect, a glow effect, a flashing effect etc. may be used. In some embodiments, the outline visual effect component may be common across all segments. In other embodiments, the outline visual effect component may differ between different segments. In such cases, outline generator module 110 may differentiate each segment through the colour value (e.g. RGB value) as stored in segment identifier attribute of the customised distance field (which will correspond to the segmentation pixel value of the associated segment of the source segmentation mask). For instance, outline generator module 110 may detect that a segment having a specific segmentation pixel value is not to be displayed. In such cases, outline generator module 110 will not generate a dynamic segment outline for that segment. In another case, outline generator module 110 may detect that a first segment having a specific first segment identifier has an outline visual effect component defining a first visual effect (e.g. a flashing effect) and a second segment having a specific second segment identifier has an outline visual effect component defining a second visual effect (e.g. a hard cut-off effect). Therefore, utilising the segment identifier attribute of the customised distance field, the customised distance field may include, for each segment, data indicating a segment being set as visible or not visible to the user and (if set as being visible to the user) each segment may be uniquely defined in terms of its outline visual effect component.

The specific configuration of application 102 may determine whether or not a segment is displayed or not displayed (i.e. visible/not visible) and what its outline visual effect component. For example, application 102 may be configured to display or not display a segment and/or may be configured to have a specific outline visual effect component based on a present context of the selected image. The context of the selected image may include input from the user. For example, in UI 300, the user input may involve activation of cursor control device 224 (e.g. a mouse click) after positioning cursor 310 is at a desired location on the image corresponding to a particular segment, thus marking that particular segment as “selected” by the user. In embodiments where a touch screen is used, this selection may be made by the user contacting the touch screen at the desired location on the image. The selected segment may then have a specific visual effect applied to its dynamic segment outline that is different to a visual effect applied to dynamic segment outlines of other non-selected segments. In another example, the user input may involve positioning cursor 310 (by way of cursor control device 224) at a desired location on the image corresponding to a particular segment, in other words cursor 310 “hovering over” a particular segment. The segment over which cursor 310 is positioned may then have a specific visual effect applied to its dynamic segment outline that is different to a visual effect applied to dynamic segment outlines of other segments.

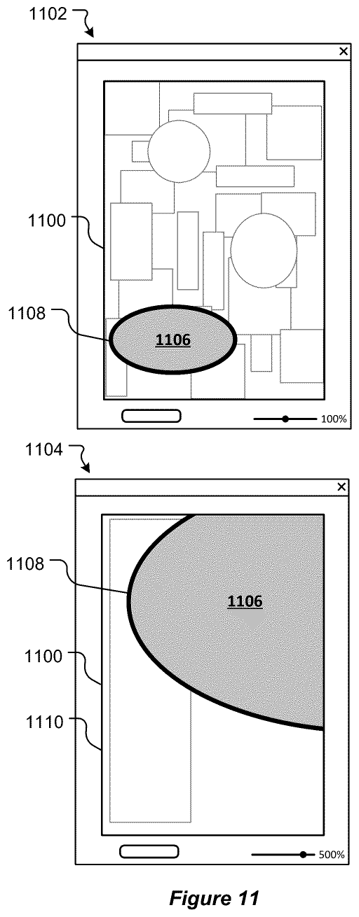

Referring to FIGS. 9A and 9B, there is illustrated examples of images as displayed to a user each showing an example overlay with dynamic segment outlines corresponding to one or more segments of the segmentation mask of FIG. 7B. Image 900 includes three segments: a first segment 912 (corresponding to first segment 712 of segmentation mask 710); a second segment 914 (corresponding to second segment 714 of segmentation mask 710); and a third segment 916 (corresponding to third segment 716 of segmentation mask 710). Each segment includes a dynamic segment outline, specifically: first segment 912 includes a first dynamic segment outline 902; second segment 914 includes a second dynamic segment outline 904; and third segment 916 includes a third dynamic segment outline 906.

Image 920 includes two visible segments: a first segment 932 (corresponding to first segment 712 of segmentation mask 710); and a second segment 934 (corresponding to second segment 714 of segmentation mask 710). Each visible segment includes a dynamic segment outline, specifically: first segment 932 includes a first dynamic segment outline 922; and second segment 934 includes a second dynamic segment outline 924. In this example, third segment 716 of segmentation mask 710 is set as not visible to the user and, therefore, in image 920 there is no corresponding segment (or dynamic segment outline) visualisation displayed to the user.

The outline visual effect component may include an outline colour value (e.g. an RGB value) defining the colour of the dynamic segment outline. Outline generator module 110 may be configured to utilise a predetermined outline colour value for the dynamic segment outlines of all segments to be displayed. However, in other embodiments, the outline colour value may be based on the segment identifier of the associated segment of the source segmentation mask (e.g. as defined by the stored segment identifier attribute of the customised distance field). For example, where a dynamic segment outline is generated for a segment having a green RGB value in the source segmentation mask, the outline colour value will have a green RGB value, and where a dynamic segment outline is generated for another segment having a purple RGB value in the source segmentation mask, the outline colour value will have a purple RGB value.

Once outline generator module 110 generates the one or more dynamic segment outlines, application 102 displays the generated one or more dynamic segment outlines to the user. At substantially the same time as displaying the one or more dynamic segment outlines, application 102 may also be configured to display a segment visual effect to the segments associated with each displayed dynamic segment outline. The segment visual effect may take the form of an overlay that may be applied based on the source segmentation mask. The overlay may take any form that serves to visually distinguish the segment from the selected image itself. This may include, for example, the use of shading (e.g. a partially transparent fill of a particular colour and/or pattern), a flashing overlay (e.g. an opaque or partially transparent fill that flashes), and/or an alternative visualisation of the segment. For example, in image 900, each of segments 912, 914 and 916 display a shading segment visual effect and in image 920, each of segments 932 and 934 display a shading segment visual effect.

The segment visual effect may also include a segment output colour value (e.g. an RGB value). Application 102 may be configured such that the segment output colour value matches the outline colour value of the dynamic segment outline. However, in other embodiments, application 102 may be configured such that the segment output colour value may be predetermined (irrespective of the outline colour value or any other colour values). In other embodiments, the segment output colour value may differ between different segments. In such cases, as it does in respect of the dynamic segment outlines (using outline generator module 110), application 102 may differentiate each segment through the colour value (e.g. RGB value) as stored in segment identifier attribute of the customised distance field (which will correspond to the segment pixel value of the associated segment of the source segmentation mask).

Where application 102 is configured to display a segment visual effect to the segments associated with each displayed dynamic segment outline, the dynamic segment outline will effectively overlay any segment visual effect such that the dynamic segment outline is fully displayed to the user. Thus, the dynamic segment outline is fully displayed and the segment having a segment visual effect may be partially displayed where the dynamic segment outline overlaps with the segment.

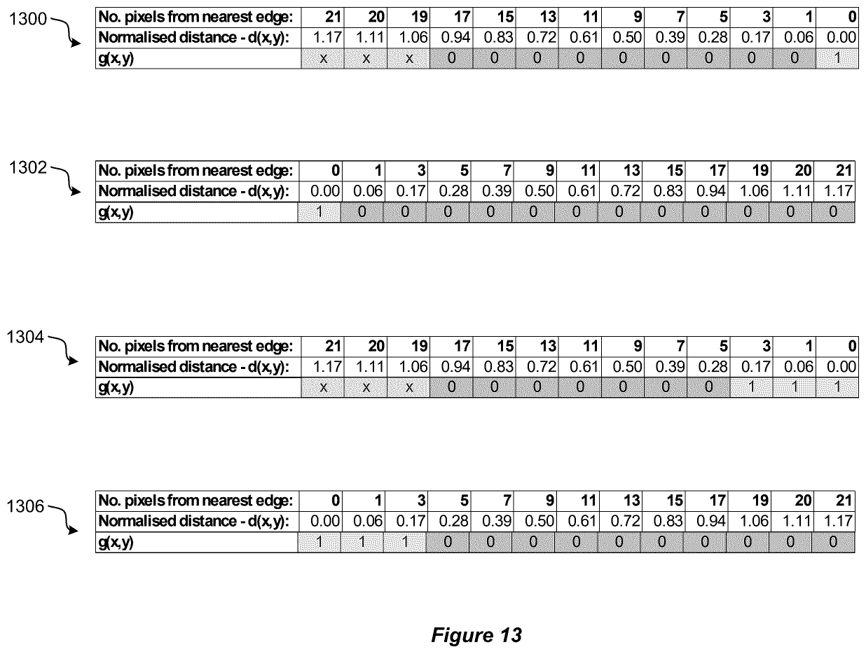

As described above, where the present zoom level (and/or the visible image portion) changes, i.e. a change in zoom level from the present zoom level to a new present zoom level is detected by application 102, the display adjusted distance field will be re-calculated and re-generated (at 408) in response to this detected change. This enables application 102 to generate the dynamic segment outline such that its display thickness (defined by the outline area component) is the same in terms of absolute thickness that the user views on their display for any zoom level. An example demonstrating the dynamic segment outlines at various zoom levels is described with reference to FIG. 11 which depicts an image 1100 and two user interface examples 1102 and 1104 (each UI example being based on the example UI 300 of FIG. 3). In the first example 1102, image 1000 is displayed at a zoom level of 100% showing a segment 1106 displayed with a dynamic segment outline 1108 (as generated by way of method 400). In the second example 1104, image 1000 is displayed at a zoom level of 500% (not shown to scale) depicting a zoomed-in portion 1110 of image 1100. The second example 1104 therefore depicts segment 1106 with dynamic segment outline 1108 (as generated by way of method 400) at a greater zoom level than that of first example 1102. However, as illustrated by examples 1102 and 1104, the display thickness of dynamic segment outline 1108 is the same in absolute thickness at both zoom levels. Thus, it is emphasised that the outline area component of dynamic segment outlines is generated (by method 600) such that the display thickness is the same at any available zoom level as displayed to the user.

A segment (having a dynamic segment outline) may be selected and various downstream processing may be performed. Such downstream processing may be carried out or enabled by application 102. However, in some embodiments, application 102 may communicate with one or more additional applications that may provide various downstream processing. Downstream processing may include a variety of editing functions that edit one or more objects in the source image that are identified by the selected segments. Examples of such editing functions include: cutting an object (that is, removing the object to selectively be pasted), copying an object, resizing an object, applying or adjusting an image effect of the object (such as a burn effect, dodge effect, brightness effect, contrast effect, saturation effect, or any other effect that can be applied to a set of pixels of an image).

Turning to FIG. 5, a method 500 for generating a customised distance field will be described. Method 500 may, for example, be performed by distance field generator module 104 of application 102 at step 404 of method 400. Method 500 may, however, be performed by distance field generator module 104 (or any other application) in other contexts where there is a desire to generate a customised distance field for an image.

In the present context, method 500 takes as an input the selected image of method 400. Based on the inputted image, at 502, distance field generator module 104 generates segmentation data defining segmentation mask. In other embodiments, segmentation data may be generated by another application that may run on system 100 or maybe on a remote system in communication with system 100, for example via network 114. Where a segmentation mask has been generated previously in respect of the inputted image, distance field generator module 104 may retrieve this segmentation mask from a data storage (e.g. data storage 112, that may be accessed via data storage module 108).

Once the segmentation data is generated (or is retrieved), at 504, distance field generator module 104 receives the segmentation data (e.g. the source segmentation mask associated with the selected image of method 400) and generates edge segmentation data defining an edge segmentation mask based on the inputted segmentation mask. An edge segmentation mask is effectively an outline of the inputted segmentation mask (comprising one or more segments) whereby the pixels at the edge of the segmentation mask maintain their pixel colour value and the remaining pixels are designated a different colour value. This different colour value may match the colour value designated to pixels of which their location does not overlie any object (e.g. a black RBG value). The resultant segments of the edge segmentation mask (that correspond to the segments of the inputted segmentation mask) may be referred to as segment edges.

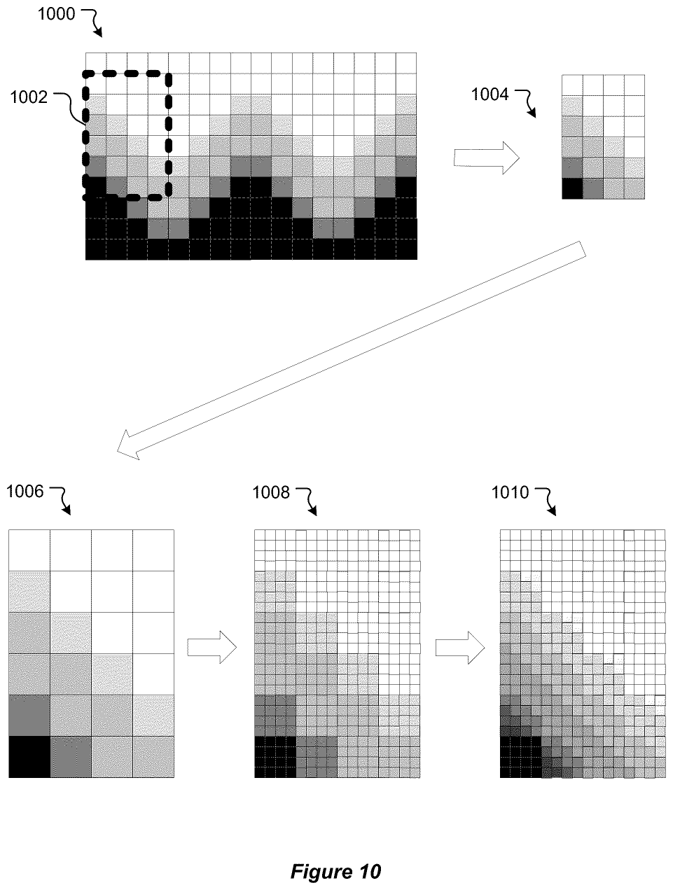

For example, referring to FIGS. 7B and 8, distance field generator module 104 may process segmentation mask 710 to generate edge segmentation mask 800. Edge segmentation mask 800 includes three edge segments that correspond to the three segments of segmentation mask 710: a first edge segment 802 (corresponding to first segment 712); a second edge segment 804 (corresponding to second segment 714); and a third edge segment 806 (corresponding to third segment 716). First edge segment 802, second edge segment 804 and third edge segment 806 maintain the colour of their corresponding segments, i.e. first edge segment 802 is purple, second edge segment 804 is green and third edge segment 806 is blue. However, the non-edge pixels, shown in FIG. 8 as first non-edge area 812, second non-edge area 814 and third non-edge area 816, are designated a black RBG value. Black area 718 of segmentation mask 710 is effectively unchanged from the source segmentation mask; in edge segmentation mask 800 this area is denoted by a corresponding area 818.

In one example, distance field generator module 104 may be configured to generate an edge segmentation mask by comparing each pixel of each segment of the inputted segmentation mask (e.g. the source segmentation mask) and its direct surrounding pixels to determine edge and non-edge pixels. More specifically, for each pixel of each segment in the segmentation mask (e.g. each pixel of the segmentation mask having a colour value indicating it is part of a segment), distance field generator module 104 may compare the colour value (e.g. the RGB value) of that pixel to all of its surrounding pixels. If all the surrounding pixels have the same colour value, distance field generator module 104 determines the pixel to be a non-edge pixel (given pixels not on the edge of the segmentation mask will have all pixels surrounding it being within the segmentation mask and thus having the same colour value). On the other hand if any of the surrounding pixels have a different colour value to the pixel, distance field generator module 104 determines the pixel to be an edge pixel (given pixels on the edge of the segmentation mask will have some pixels surrounding it being within the segmentation mask thus having the same colour value and at least one pixel surrounding it being outside the segmentation mask thus having a different colour value). Once distance field generator module 104 determines the edge and non-edge pixels, each edge pixel will be assigned the same colour value (e.g. the RGB value) as that of its corresponding segment of the segmentation mask (e.g. the source segmentation mask) and each non-edge pixel will be assigned a different colour value (e.g. a non-segment RGB value such as a black RGB value) to that of its corresponding segment of the segmentation mask (e.g. the source segmentation mask). That different colour value may be the same colour value as pixels in the segmentation mask that are not occupied by a segment (e.g. as illustrated in edge segmentation mask 900 where first non-edge area 912, second non-edge area 914 and third non-edge area 916 are designated the same black RBG value as area 918). Therefore, the generated edge segmentation mask will include one or more edge segments that correspond to the one or more segments of the inputted segmentation mask.

Once the edge segmentation mask is generated, at 506, distance field generator module 104 determines a maximum distance value. The maximum distance value is a relative distance value which may be determined based on a dimension of an image (e.g. the selected image of method 400). More specifically, the maximum distance value may be determined relative to the resolution of the selected image (e.g. the resolution image data attribute). In present examples, the maximum distance value is determined by way of a predefined maximum distance value calculation. The predefined maximum distance value calculation may be based on the length of the longest dimension of the image. However, in other embodiments, the predefined maximum distance value calculation may be based on another length, e.g. the length of the shorter dimension of the image.

Where the predefined maximum distance value calculation is based on the longest dimension of the selected image, the maximum distance value may, for example, be calculated as of 1% of the longest length of the selected image. For example, where the selected image has a resolution of 1800 pixels by 1200 pixels, the maximum distance value will be 18 pixels (predefined maximum distance value calculation of 1% of the 1800 pixel dimension, the longer dimension of the image). In other embodiments, the predefined maximum distance value calculation may be other than 1% of the longest length of the image. For example, the predefined maximum distance value calculation may be based on a portion of the longer dimension of the image in the range of about 0.1% to about 10%. The predefined maximum distance value calculation may generally be selected taking into account factors such as the number of segments, the zoom level, and the size of image on the user's display (i.e. how much of the display the image will take up at the zoom level), amongst others.

Once the maximum distance value is determined, at 508, distance field generator module 104 (coordinated by application 102) generates a distance field pixel value corresponding to each input image pixel of the selected image. For each input image pixel, this includes calculating a pixel distance value which indicates the distance between the corresponding image pixel and a nearest segment edge.

In the present embodiment, the distance value for each distance field pixel is calculated according to the following distance field function (Eq. (1)) is as follows:

$$f ( x , y ) = \{ \begin{matrix}1 , if d ( x , y ) > 1 and ( x , y ) ∉ Ω \\ 0 , if d ( x , y ) > 1 and ( x , y ) ∈ Ω \\ \frac{d ( x , y )}{2} + 0.5 , if d ( x , y ) < 1 and ( x , y ) ∉ Ω \\ 0.5 - \frac{d ( x , y )}{2} , d ( x , y ) < 1 and ( x , y ) ∈ Ω\end{matrix} \qquad Eq . ( 1 )$$

In Eq. (1): f(x,y) is a function value defining the pixel distance values of a pixel at location x,y, in the form of a normalised pixel distance (in this example a function value is equal to or greater than 0 and equal or less than 1); d(x,y) is the normalised pixel distance between the pixel at location x,y to a nearest pixel of the edge segmentation mask (i.e. the nearest edge pixel) which is compared to a normalised maximum distance value; and Ω is a segment that has been identified in the source segmentation mask.

The normalised maximum distance value may be calculated based on the selected maximum distance value (from 508). This calculation is such that: an absolute pixel distance at or greater than the selected maximum distance value is designated a normalised pixel distance equal to the normalised maximum distance value (e.g. 1 as per Eq. (1)); and an absolute pixel distance less than the selected maximum distance value is designated a normalised pixel distance between 0 (i.e. at the location of the pixel) and the normalised maximum distance value (e.g. 1). In other embodiments, a normalised values in a range of other than 0 to 1 may be used, for example 0 to 10 or any other range which has a finite maximum and minimum value.

In addition, distance field generator module 104 determines a segment identifier for each distance field pixel value. In the present embodiment, the segment identifier for a given distance field pixel is the RGB value of the segment edge to which the distance field pixel is nearest (i.e. the nearest edge pixel).

Once the distance field function is retrieved, at 510, distance field generator module 104 outputs the customised distance field. The customised distance field enables calculation of the function value based on a calculated normalised pixel distance (as compared to the normalised maximum distance value) and the pixel colour value.

As per Eq. (1), a pixel within a segment of the source segmentation mask and at or beyond the maximum distance value (i.e. the normalised pixel distance of the pixel is greater than the normalised maximum distance value) will be assigned a minimum pixel distance value (i.e. a function value of 0). A pixel not within the segment(s) of the source segmentation mask and at or beyond the maximum distance value (i.e. the normalised pixel distance of the pixel is greater than the normalised maximum distance value) will be assigned a maximum distance value (i.e. a function value of 1). The function value of pixels within the maximum distance value will be effectively assigned a function value of between 0 and 1 based on the normalised pixel distance between the specific pixel and its nearest edge pixel. That is, a pixel not within the segment(s) of the source segmentation mask and within the maximum distance value (i.e. the normalised pixel distance of the pixel is less than the normalised maximum distance value) will be assigned a location dependent pixel distance value between a value half way between the minimum and maximum value and the maximum value (i.e. a function value between 0.5 and 1). And, a pixel within a segment of the source segmentation mask and within the maximum distance value (i.e. the normalised pixel distance of the pixel is less than the normalised maximum distance value) will be assigned a location dependent pixel distance value between the minimum value and the value half way between the minimum and maximum value (i.e. a function value between 0 and 0.5).

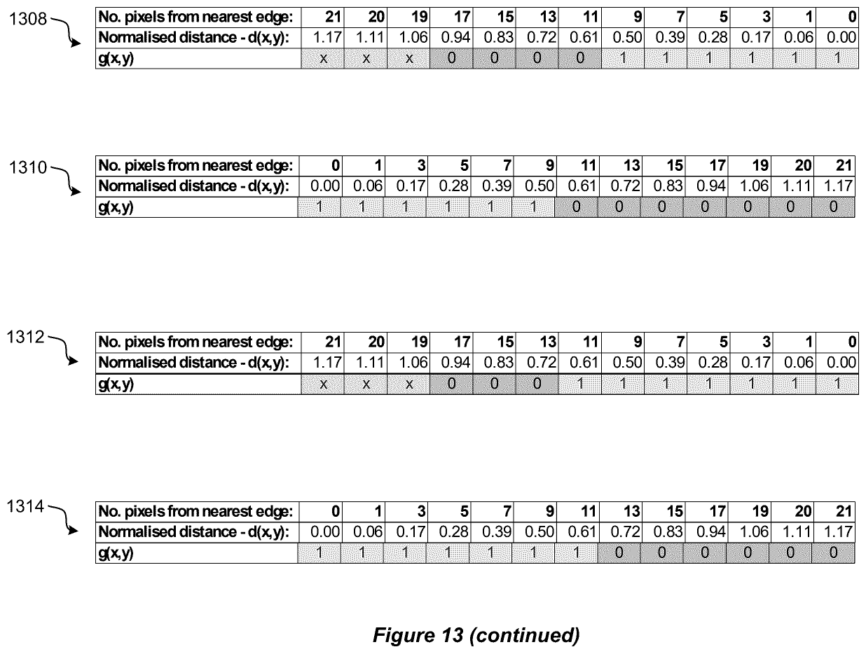

To more clearly explain the calculation of the function values of Eq. (1), FIG. 12 provides a series of tables having sets including example pixel distance values. The examples are provided using the above example where the selected image has a resolution of 1800 pixels by 1200 pixels, the maximum distance value being selected as 18 pixels.

Referring to table 1200, there is shown a set of example values for pixels located outside a segment with: the first row showing the distance (in pixels) from the segment's edge (a distance of 0 indicating a pixel on the segment edge); the second row showing the normalised pixel distance (d(x,y) from Eq. (1)); and the third row showing the pixel distance value (f(x,y) from Eq. (1)) calculated using Eq. (1).

Referring to Table 1202, there is shown a set of example values for pixels located within a segment with: the first row showing the distance (in pixels) from the segment's edge (a distance of 0 indicating a pixel on the segment edge); the second row showing the normalised pixel distance (d(x,y) from Eq. (1)); and the third row showing the pixel distance value (f(x,y) from Eq. (1)) calculated using Eq. (1).

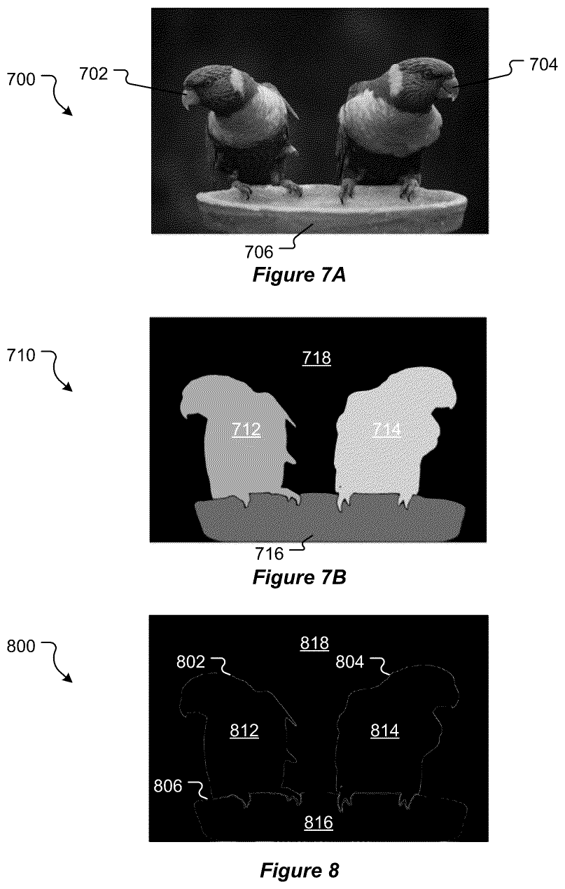

Turning to FIG. 6, a method 600 for determining an outline area component of a dynamic segment outline will be described. Method 600 may, for example, be performed by outline generator module 110 of application 102 at step 410 of method 400. Method 600 may, however, be performed by outline generator module 110 (or any other application) in other contexts where there is a desire to determine an outline area component of a dynamic segment outline.

In the present context, method 600 takes as an input: display adjusted distance field portion (e.g. as generated at 408 of method 400); a pixel location on the display adjusted resolution; the present zoom level; a maximum zoom level; and data indicating a segment being set as visible or not visible to the user. Outline generator module 110 then carries out method 400 in respect of each pixel location on the display adjusted resolution.

At 602, outline generator module 110 determines if the pixel location is within a segment that is set as visible and thus is to be displayed to the user. This determination is based on the inputted data indicating a segment being set as visible or not visible to the user. If outline generator module 110 determines that the pixel location is within a segment that is set as visible and thus is to be displayed to the user, at 604, outline generator module 110 determines if the pixel location is within the maximum distance value of the nearest edge pixel. If outline generator module 110 determines that the pixel location is within the maximum distance value of the nearest edge pixel, at 606, outline generator module 110 determines an outline value for the pixel location. The outline value for the pixel location is a binary value (e.g. 0 or 1) that determines if a pixel location is within the dynamic segment outline.

Outline generator module 110 may determine an outline value for the pixel location by firstly determining a normalised zoom level based on the present zoom level and the maximum zoom level. One example of an equation determining a normalised zoom level (Eq. (2)) is as follows:

$$z ( x , y ) = ( {Z}_{Max} - {Z}_{P resent} ) / {Z}_{Max} \qquad Eq . ( 2 )$$

In Eq. (2): z(x,y) is the normalised zoom level; Z_{Max} is the maximum zoom level; and Z_{Present} is the present zoom level.

Outline generator module 110 may then determine the outline value for a pixel location. One example of an equation determining the outline value (Eq. (3)) is as follows:

$$g ( x , y ) = \{ \begin{matrix}1 , if d ( x , y ) \leq z ( x , y ) \\ 0 , if d ( x , y ) > z ( x , y )\end{matrix} \qquad Eq . ( 3 )$$

In Eq. (3): g(x,y) is the outline value of at a pixel location x,y, (the value may be 1 or 0); d(x,y) is the normalised pixel distance between the pixel at location x,y to a nearest pixel of the edge segmentation mask; and z(x,y) is the normalised zoom level.

If, at 602, outline generator module 110 determines that the pixel location is not within a segment that is set as visible and thus is not to be displayed to the user, at 608, outline generator module 110 disregards the pixel location, effectively determining the outline value as 0. Similarly, if at 604, outline generator module 110 determines that the pixel location is not within the maximum distance value of the nearest edge pixel, at 608, outline generator module 110 disregards the pixel location, effectively determining the outline value as 0.

Once outline generator module 110 has determined the outline value for each pixel location (either 1 or 0), the outline area component may be defined as comprising each pixel with an outline visibility value of 1. The outline area component determined by method 600 will produce a dynamic segment outline with a uniform display thickness.

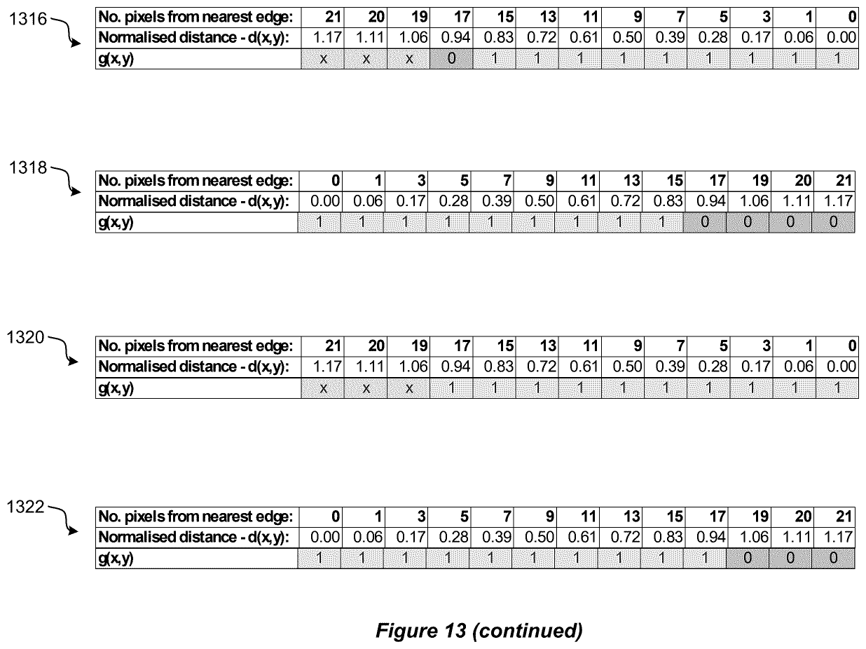

To more clearly explain the calculation of the outline values of Eq. (3) that define the outline area component, FIG. 13 provides a series of tables including example outline values in respect of various example zoom levels. The example of FIG. 13 uses the example values of tables 1200 and 1202 to calculate outline values. In the following example, the maximum zoom level is taken to be 10.

Referring to table 1300, there is shown a set of example values for pixels located outside a segment where the current zoom level is 10 (i.e. the current zoom level is the maximum zoom level), thus the normalised zoom level is 0. In table 1300: the first row shows the distance (in pixels) from segment edge (a distance of 0 indicating a pixel on the segment edge); the second row shows the normalised pixel distance (d(x,y) from Eq. (1) and Eq. (3)); and the third row shows the outline value (g(x,y) from Eq. (3)). As per 608, if the pixel location is not within the maximum distance value of the nearest edge pixel (e.g. for the maximum distance value of 18 pixels, pixels that are located 19, 20 and 21 pixels from the nearest edge are outside this maximum distance value and are thus disregarded). In this case, only the pixels at the edge have a value of 1 and only these pixels will form part of the outline area component.

Referring to table 1302, there is shown a set of example values for pixels located within a segment where the current zoom level is 10 (i.e. the current zoom level is the maximum zoom level), thus the normalised zoom level is 0. In table 1302: the first row shows the distance (in pixels) from segment edge (a distance of 0 indicating a pixel on the segment edge); the second row shows the normalised pixel distance (d(x,y) from Eq. (1) and Eq. (3)); and the third row shows the outline value (g(x,y) from Eq. (3)). Again, no pixels (except for those at the edge as discussed above with reference to Eq. (3)) will form part of the outline area component.

Referring to table 1304, there is shown a set of example values similar to that of table 1300 except where the current zoom level is 8, thus the normalised zoom level is 0.2. In this case, the pixels that have a normalised pixel distance of less than 0.2 will form part of the outline area component.

Referring to table 1306, there is shown a set of example values similar to that of table 1302 except where the current zoom level is 8, thus the normalised zoom level is 0.2. In this case, the pixels that have a normalised pixel distance of less than 0.2 will form part of the outline area component.

Referring to table 1308, there is shown a set of example values similar to that of table 1300 except where the current zoom level is 5, thus the normalised zoom level is 0.5. In this case, the pixels that have a normalised pixel distance of less than 0.5 will form part of the outline area component.

Referring to table 1310, there is shown a set of example values similar to that of table 1302 except where the current zoom level is 5, thus the normalised zoom level is 0.5. In this case, the pixels that have a normalised pixel distance of less than 0.5 will form part of the outline area component.

Referring to table 1312, there is shown a set of example values similar to that of table 1300 except where the current zoom level is 3, thus the normalised zoom level is 0.7. In this case, the pixels that have a normalised pixel distance of less than 0.7 will form part of the outline area component.

Referring to table 1314, there is shown a set of example values similar to that of table 1302 except where the current zoom level is 3, thus the normalised zoom level is 0.7. In this case, the pixels that have a normalised pixel distance of less than 0.7 will form part of the outline area component.

Referring to table 1316, there is shown a set of example values similar to that of table 1300 except where the current zoom level is 1, thus the normalised zoom level is 0.9. In this case, the pixels that have a normalised pixel distance of less than 0.9 will form part of the outline area component.

Referring to table 1318, there is shown a set of example values similar to that of table 1302 except where the current zoom level is 1, thus the normalised zoom level is 0.9. In this case, the pixels that have a normalised pixel distance of less than 0.9 will form part of the outline area component.

Referring to table 1320, there is shown a set of example values similar to that of table 1300 except where the current zoom level is 0, thus the normalised zoom level is 1. In this case, the pixels that have a normalised pixel distance of less than 1 will form part of the outline area component.

Referring to table 1322, there is shown a set of example values similar to that of table 1302 except where the current zoom level is 0, thus the normalised zoom level is 1. In this case, the pixels that have a normalised pixel distance of less than 1 will form part of the outline area component.

It will be appreciated that whilst there are known methods for generating segment outlines of a certain thickness, these known methods involve static generation of the segment outlines. This static generation will result in zooming in or out to respectively increase or decrease the thickness of the segment outline. Thus, in order for the segment outline to be shown at a consistent absolute display thickness at any zoom level, the entire segment outline must be re-computed with entirely new inputs. Advantageously, systems and methods disclosed herein processing efficiencies as certain calculations (e.g. generating a customised distance field for a selected image) will not need to be re-computed and can simply be retrieved to use.

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

To illustrate the types of features that application 102 may provide, FIG. 3 provides an example of a user interface, UI 300. UI 300 may be one such GUI of the user interface of application 102. Application 102 may include a variety of GUIs. It will be appreciated that other GUIs may exist as part of application 102 or other applications that may facilitate the same or similar user interaction as example GUI 300.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

In some instances, the present disclosure and/or claims may use the terms “first”, “second”, etc. to identify and distinguish between elements or features. When used in this way, these terms are not used in an ordinal sense and are not intended to imply any particular order. For example, a first zoom level could equally be referred to a second zoom level without departing from the scope of the described examples. Furthermore, when used to differentiate elements or features, a second feature could exist without a first feature or a second feature could exist before a first feature.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method including:
displaying an image at a first zoom level on a display;
generating first display adjusted distance field data based on distance field data associated with the image and one or more context inputs, wherein the one or more context inputs includes the first zoom level; and
generating, based on the first display adjusted distance field data, a first dynamic segment outline corresponding to a first segment of the image, wherein the first dynamic segment outline has a first outline thickness that substantially equals a display thickness, the display thickness being substantially the same for any zoom level.

2. The computer implemented method according to claim 1 including the further step of displaying the first dynamic segment outline on the display such that the first dynamic segment outline overlies the image.

3. The computer implemented method according to claim 2 including the further step of displaying a first segment within the first dynamic segment outline.

4. The computer implemented method according to claim 3 wherein the displayed first segment includes a predefined segment visual effect.

5. The computer implemented method according to claim 1 wherein the distance field data includes a set of distance field pixel values, each distance field pixel value corresponding to a pixel of the image with which the distance field is associated, wherein each distance field pixel value includes a segment identifier that identifies a segment to which the corresponding pixel is closest.

6. The computer implemented method according to claim 5 wherein the segment identifier is a colour value of the segment to which the corresponding pixel is closest.

7. The computer implemented method according to claim 1 wherein the one or more context inputs includes a resolution of the display.

8. The computer implemented method according to claim 1 wherein the one or more context inputs includes a present visible image portion.

9. The computer implemented method according to claim 1 wherein the method further includes:
generating, based on the generated display adjusted distance field data, a second dynamic segment outline, the second dynamic segment outline corresponding to a second segment of the image, wherein the second dynamic segment outline has the first outline thickness.

10. The computer implemented method according to claim 1 wherein the method further includes:
detecting a change in zoom level from the first zoom level to a second zoom level, the second zoom level being different to the first zoom level, and, in response to detecting the change in zoom level:
displaying the image at the second zoom level;
generating second display adjusted distance field data based on the distance field data associated with the image and the second zoom level; and
generating a third dynamic segment outline based on the second display adjusted distance field data, wherein the third dynamic segment outline corresponds to the first segment of the image wherein the third dynamic segment outline has the first outline thickness.

11. The computer implemented method according to claim 1 further including generating distance field data by:
accessing image data in respect of the image;
receiving segmentation data associated with the image, wherein the segmentation data defines one or more segments in the image;
processing the segmentation data to generate edge segmentation data, wherein for each segment the edge segmentation data defines a corresponding segment edge; and
processing the segmentation data and the edge segmentation data to generate the distance field data, wherein the distance field data includes for each pixel of the image a pixel distance value, and wherein each pixel distance value indicates a distance between each pixel and its nearest segment edge.

12. The computer implemented method according to claim 11 wherein generating distance field data further includes:
determining a maximum distance value; and
for each pixel of the image, comparing a normalised pixel distance to a normalised maximum distance value based on the selected maximum distance value to determine the pixel distance values whereby:
for pixels where the normalised pixel distance is greater than the normalised maximum distance value and the pixel is not within the one or more segments, a pixel distance value is assigned a maximum value;
for pixels where the normalised pixel distance is greater than the normalised maximum distance value and the pixel is within the one or more segments, a pixel distance value is assigned a minimum value;
for pixels where the normalised pixel distance is less than the normalised maximum distance value and the pixel is not within the one or more segments, a pixel distance value is assigned a location dependent value between a value half way between the minimum and maximum value and the maximum value; and
for pixels where the normalised pixel distance is less than the normalised maximum distance value and the pixel is within the one or more segments, a pixel distance value is assigned a location dependent value between the value half way between the minimum and maximum value and the minimum value.

13. The computer implemented method according to claim 12 wherein the maximum distance value is determined based on a dimension of the image.

14. The computer implemented method according to claim 11 wherein receiving segmentation data associated with the image includes generating the segmentation data associated with the image.

15. The computer implemented method according to claim 11 wherein the distance field data includes a set of distance field pixel values, each distance field pixel value corresponding to a pixel of the image with which the distance field is associated, wherein each distance field pixel value includes a segment identifier that identifies a segment to which the corresponding pixel is closest, wherein the segment identifier is a colour value of the segment to which the corresponding pixel is closest.

16. The computer implemented method according to claim 15 wherein processing the segmentation data to generate edge segmentation data includes:
for each pixel of a first segment in the segmentation mask, comparing the pixel colour value of the pixel to the pixel colour value of its surrounding pixels, whereby:
for pixels where the pixel colour value of all the surrounding pixels is the same as the pixel colour value of the pixel, determining the pixel to be a non-edge pixel;
for pixels where the pixel colour value of at least one of the surrounding pixels is not the same as the pixel colour value of the pixel, determining the pixel to be an edge pixel;
assigning each edge pixel a first colour value; and
assigning each non-edge pixel a second colour value.

17. The computer implemented method according to claim 16 wherein each pixel within the first segment includes a first segment colour value and the first colour value is the first segment colour value of the first segment.

18. The computer implemented method according to claim 17 wherein processing the segmentation data to generate edge segmentation data includes:
for each pixel of a second segment in the segmentation mask, comparing the pixel colour value of the pixel to the pixel colour value of its surrounding pixels, whereby:
for pixels where the pixel colour value of all the surrounding pixels is the same as the pixel colour value of the pixel, determining the pixel to be a non-edge pixel;
for pixels where the pixel colour value of at least one of the surrounding pixels is not the same as the pixel colour value of the pixel, determining the pixel to be an edge pixel;
assigning each edge pixel a third colour value; and
assigning each non-edge pixel a second colour value.

19. A computer processing system including:
one or more a computer processing units;
a display;
a user input device; and
non-transitory computer-readable storage medium storing instructions, which when executed by the computer processing unit, cause the computer processing unit to perform a method according to claim 1.

20. Non-transitory storage medium storing instructions executable by one or more computer processing units to cause the one or more computer processing units to perform a method according to claim 1.
